(19) United States
(12) Patent Application Publication
(10) Pub. No.: US 2004/0045400 A1
(43) Pub. Date: Mar. 11, 2004

(54) Bicycle crank arm bearing bracket

(75) Inventor: Corey J. Alley, Madeira Beach, FL (US)

Correspondence Address: LARSON AND LARSON, 11199 69TH STREET NORTH, LARGO, FL, 33773

(73) Assignee: PROFILE RACING, INC.

(21) Appl. No.: 10/237,943

(22) Filed: Sep. 9, 2002

(51) Int. Cl. G05G 1/14

(52) U.S. Cl. 74/594.1

(57) ABSTRACT

A longitudinal axle is centered within a shell housing welded to a bicycle frame. A portion of each end of the axle engages a bicycle crank. Threaded male and female bracket are threadably engaged around the axle within the shell housing. A bearing is mounted within an outboard portion of each bracket and is held in place by an end cap. An outer rim of the outboard portion of each bracket has an irregular surface for engagement with a wrench to take the bracket apart.

### BACKGROUND OF THE INVENTION

This invention relates to bicycle crank arm bearing brackets. More specifically, it refers to a pair of bearing brackets threadably engaged together within a shell housing and supporting an axle on bearings mounted within an outboard portion of each bearing bracket.

Conventional American style bottom brackets on bicycles are installed using a press tool to push bearing cups tightly into a bottom bracket. To repair failed bearings in the cups, the bracket and cups must be knocked out of their shell housing which is welded to the bike frame. This is an expensive and time consuming job which this invention seeks to improve upon. Because of the bracket configuration in American style bottom brackets the bearing cups sometime are too loosely or too tightly mounted in the bracket ends and as a result misaligned bearing could occur.

Patents that included threaded bearings supporting an axle engaged to crank arms include U.S. Pat. Nos. 2,280,936; 3,220,784; 5,209,581; and 5,233,885. Although these patents relate to unconventional means for removing bottom brackets, they do not provide a simple inexpensive system of removing bottom bracket parts. Such a system is needed in the bicycle industry.

### SUMMARY OF THE INVENTION

The present invention provides a system for replacing bearings and other components of a crank arm bracket inexpensively and with less effort than accomplished heretofore. In addition, the bearings are consistently aligned with the axle. The crank arm bearing bracket of this invention has a cylindrical shell housing with a smooth annular inner surface accommodating a longitudinal axle having splines or other bicycle crank arm mounting portions at each end. The shell housing is fixed in place by being welded to the bicycle frame. A threaded male bracket and complimentary female bracket are threadably engaged around the axle within the shell housing. The ends of the axle project axially out from outboard ends of each bracket and can be splined or have other configuration to mount the crank arm. A bearing supports the axle within the outboard end of each bracket and an end cap holds the bearing perfectly aligned in place within the brackets. An irregular surface on an outer rim of each outboard portion of the brackets permits engagement of a wrench to separate the brackets.

### BRIEF DESCRIPTION OF THE DRAWINGS

The invention can be best understood by those having ordinary skill in the art by reference to the following detailed description when considered in conjunction with the accompanying drawings in which:

FIG. 1 is an exploded view of the crank arm bearing bracket of this invention.

FIG. 2 is a perspective view of the crank arm bearing bracket assembled.

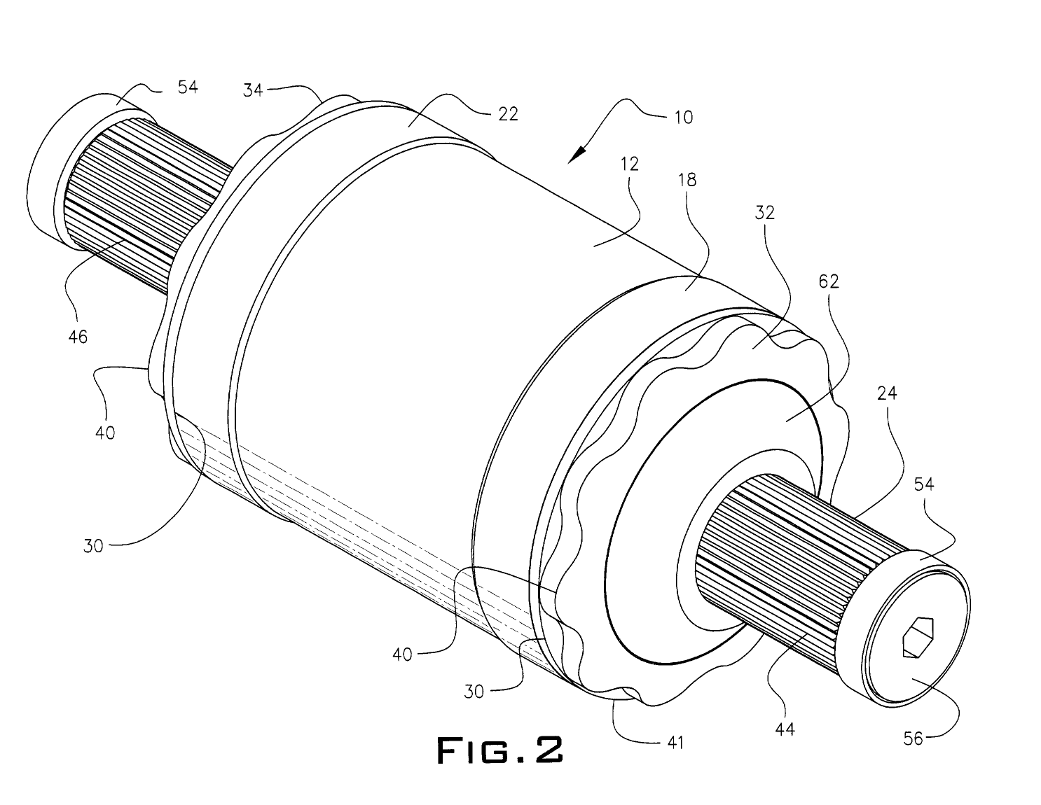

FIG. 3 is a perspective view of the shell housing welded to a bicycle frame.

FIG. 4 is a right side elevational view of a portion of the bicycle frame with the crank arms installed on the bracket axle splined ends.

### DETAILED DESCRIPTION OF THE BEST MODE

Throughout the following detailed description, the same reference numerals refer to the same elements in all figures.

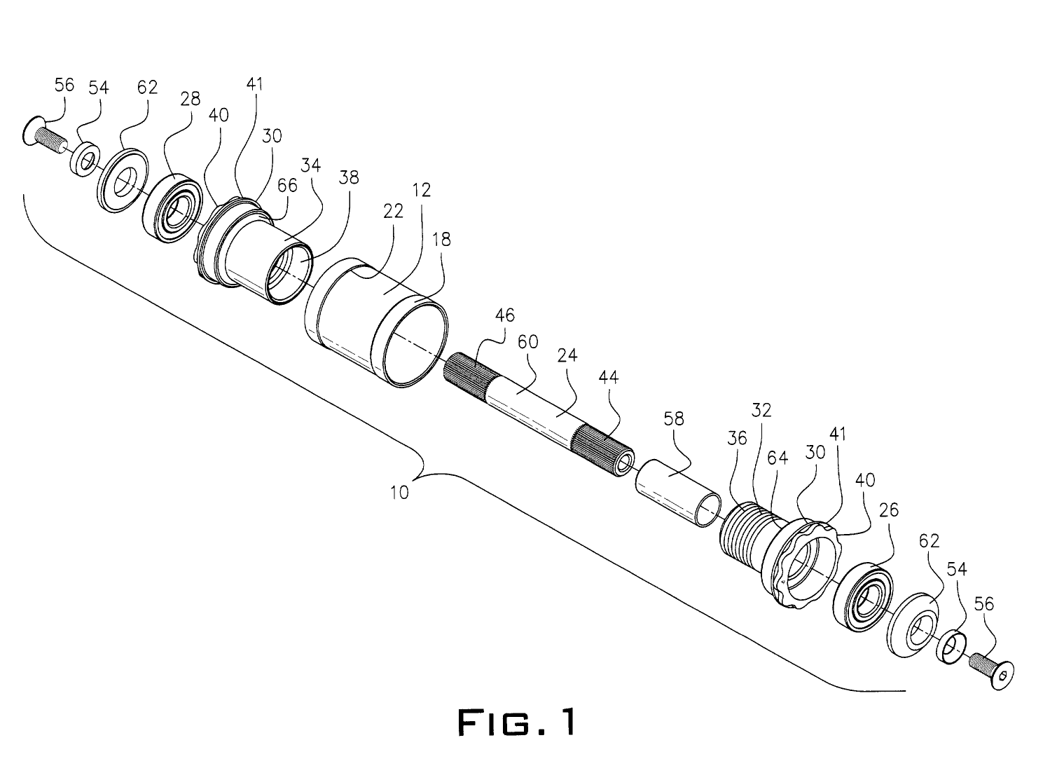

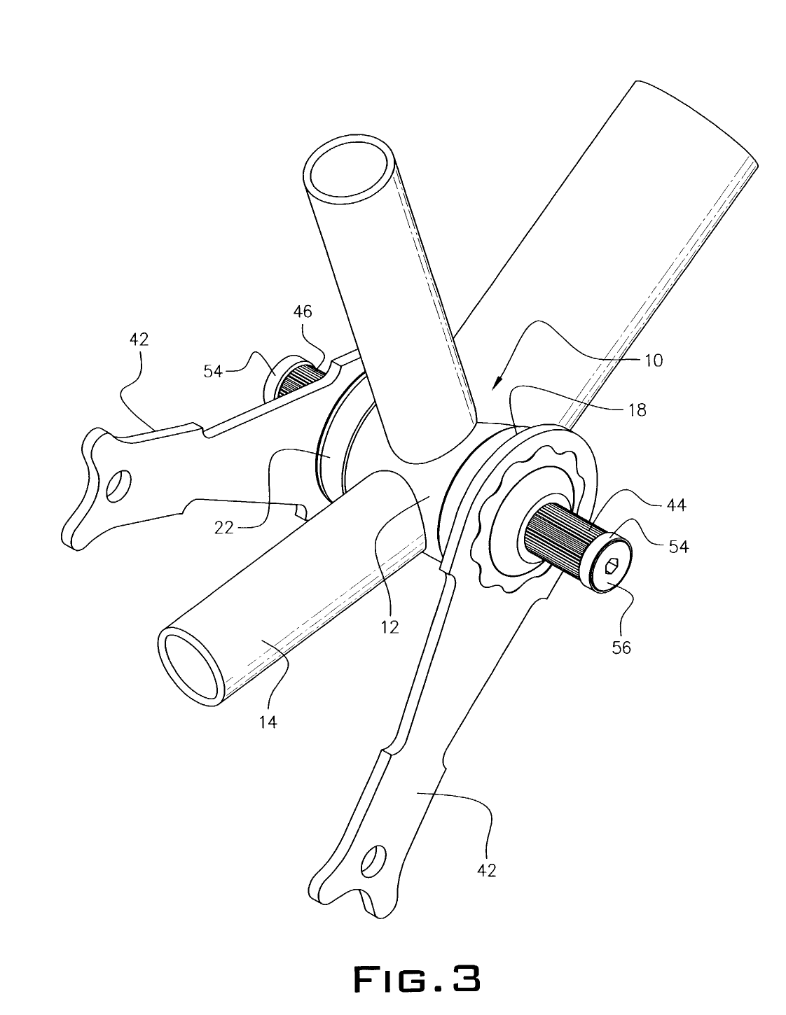

Referring to FIG. 1, the crank arm bearing bracket 10, has a shell housing 12 welded to a bicycle frame 14 as seen in FIG. 3. An inner annular surface of the shell housing is smooth. A first end 16 of the shell housing 12 has a raised edge or flange 18 and likewise a second end 20 of the shell housing 12 has a raised edge or flange 22. An axle 24 is centered within the interior of the shell housing 12 and is supported therein by bearings 26 and 28 which are mounted within an outboard portion 30 of a threaded bracket 32 and 34, respectively. Bracket 32 has male threads on an inboard portion 36 and bracket 34 has female threads on an inner surface 38. The brackets 32 and 34 are threadably engaged together inside shell housing 12. Each bracket 32 and 34 have an irregular pattern 40 along an outer rim 41 of outboard portion 30. Irregular pattern 40 is complementary to the inner portion of a wrench 42 which is used both to engage and disengage the brackets 32 and 34.

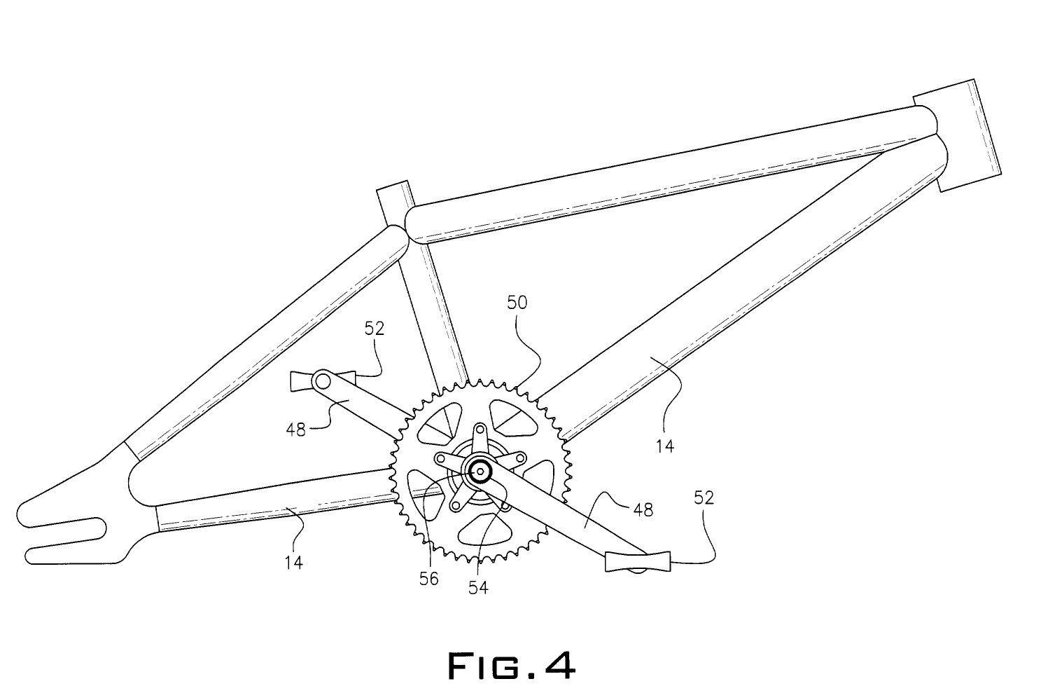

Each end 44 and 46 of axle 24 has a splined configuration for engaging a crank arm 48 and sprocket 50 as seen in FIG. 4. Other configurations such as a rectangular or square end could be substituted. A standard foot peddle 52 is located at one end of the crank arm 48 distal from bearing bracket 10. A flush mounted washer 54 and threaded bolt 56 inserted at each outside end of axle 24 hold the crank arm 48 on the axle 24. A center sleeve 58 surrounds a mid-section 60 of axle 24 within the shell housing 12. Each end of axle 24 has a threaded bolt hole 60 to accommodate threaded bolt 56. End caps 62 are press fit into the outboard portions 30 of each bracket 32 and 34 to hold bearings 26 and 28, respectively in place.

The crank arm bearing bracket 10 components are made from steel, brass or high strength aluminum. If a component such as bearings 26 or 28 fail, one merely has to use a wrench 42 to disengage the brackets 32 and 34 after removing bolt 56 and washer 54. The end cap 62 easily snaps out to expose the bearing 26 or 28 for replacement. Upon re-engagement, the flanges 18 and 22 abut edges 64 and 66, respectively to prevent over tightening of brackets 32 and 34.

Other equivalent components can be substituted for the components disclosed herein to produce the same results in the same way.

Having described the invention, what is claimed as Letters Patent follows:

1. An axle structure for a bicycle comprising:
a cylindrical shell housing welded to a bicycle frame;
a longitudinal axle centered within the shell, the axle having a bicycle crank arm engaging portion at each end projecting axially from a first and second end of the shell housing;
a threaded male bracket having an annular raised surface on an outboard portion, the raised surface abutting a flange on the first end of the shell housing and a complimentary threaded female bracket having an annular raised surface on an outboard portion, the raised surface abutting a flange on the second end of the shell housing, a bearing supporting the axle within the outboard portion of the male and female brackets, the male and female bracket threadably engaged inside the shell housing;
an end cap enclosing the outboard portion of each bracket, the end caps having a center channel to accommodate the axle, each end cap retaining the bearing within the outboard portion of the male and female bracket, respectively;
a means for retaining the bicycle crank arm in place at each end of the axle; and
an outer rim of each bracket having a means for engagement with a wrench.

2. The axle structure for a bicycle according to claim 1 wherein a first and second end of the axle has a threaded axial bore for receipt of a threaded bolt to retain the crank arm on the axle.

3. The axle structure for a bicycle according to claim 1 wherein the means for retaining the bicycle crank in place is a washer and a bolt threadably engaged to an axially threaded bore at each end of the axle.

4. The axle structure for a bicycle according to claim 1 wherein the means for engagement with a wrench is an irregular surface on the outer rim of each bracket.

5. The axle structure for a bicycle according to claim 1 wherein the cylindrical shell has a smooth inner annular wall.

6. The axle structure for a bicycle according to claim 1 wherein the bicycle crank arm engaging portion at each end is splined.

7. A bicycle crank arm bracket comprising:
a shell housing integral with a bicycle frame;
a male and female substantially cylindrical bracket threadably engaged within the shell housing;
a bearing mounted within an outboard portion of the male and female bracket;
an axle mounted on the bearings, the axle passing through the male and female brackets and a first and second axle end projecting outwardly axially from the outboard portion of the male and female brackets, the first and second end of the axle having a means to accommodate a crank arm;
an end cap enclosing the outboard portion of the male and female bracket, the end caps having a center channel to accommodate the axle, each end cap retaining the bearing within the outboard portion of the male and female bracket;
means for retaining the bicycle crank arm in place at the first and second end of the axle; and
an outer rim of the male and female bracket having a means for engagement with a tool for disengaging the brackets.

8. A bicycle crank arm bracket according to claim 7 wherein the shell housing is welded to the bicycle frame.

9. A bicycle crank arm bracket according to claim 7 wherein the male and female brackets have an annular raised portion on an exterior surface of the outboard portion for engagement with a flange on an exterior surface at a first and second end of the shell housing.

10. A bicycle crank arm bracket according to claim 7 wherein the means for retaining the bicycle crank arm in place is an axial bore at the first and second end of the axle and a bolt threadably engaged to the axial bore at the first and second end of the axle.

11. A bicycle crank arm bracket according to claim 7 wherein the means for engagement with a tool is an irregular surface on an outer rim of the male and female bracket.

12. A bicycle crank arm bracket according to claim 7 wherein the tool is a wrench having inner teeth complementary with the irregular surface on the outer rim of the male and female bracket.

13. A bicycle crank arm bracket according to claim 7 wherein the shell housing has a smooth annular inner wall.

14. A bicycle crank arm bracket according to claim 7 wherein the means to accommodate a crank arm is a splined portion.
